(19) United States
(12) Patent Application Publication
(10) Pub. No.: US 2013/0000609 A1
(43) Pub. Date: Jan. 3, 2013

(54) FUEL VAPOR PROCESSING APPARATUS

(75) Inventors: Norihisa YAMAMOTO, Obu-shi (JP); Tsuneyuki KURATA, Obu-shi (JP); Masamitsu HAYAKAWA, Obu-shi (JP); Ryuji KOSUGI, Obu-shi (JP); Shinji SHIMOKAWA, Toyota-shi (JP); Yuusaku NISHIMURA, Toyota-shi (JP); Shinsuke KIYOMIYA, Toyota-shi (JP); Masahide KOBAYASHI, Toyota-shi (JP)

(73) Assignees: TOYOTA JIDOSHA KABUSHIKI KAISHA, Toyota-shi (JP); AISAN KOGYO KABUSHIKI KAISHA, Obu-shi (JP)

(21) Appl. No.: 13/539,364

(22) Filed: Jun. 30, 2012

(30) Foreign Application Priority Data
Jun. 30, 2011 (JP) 2011-145766

(51) Int. Cl. F02M 33/02

(52) U.S. Cl. 123/519

(57) ABSTRACT

A fuel vapor processing apparatus includes a case defining therein a flow passage including an adsorption chamber, an adsorption material disposed in the adsorption chamber; and a density gradient filter disposed in the flow passage at a position on an upstream side of the adsorption material with respect to a direction of flow of purge air for desorbing fuel vapor from the adsorption material. The density gradient filter includes a first portion having a first density, a second portion having a second density, and a third portion having a third density. The third portion is positioned on a downstream side of the first portion with respect to the direction of flow of the purge air and the second portion is positioned between the first portion and the third portion. Each of the first density and the third density is higher than the second density.

This application claims priority to Japanese patent application serial number 2011-145766, the contents of which are incorporated herein by reference.

### BACKGROUND OF THE INVENTION

1. Field of the Invention

Embodiments of the present invention relate to fuel vapor processing apparatus known as canisters that are mounted mainly to vehicles.

2. Description of the Related Art

JP-A-2009-222045 teaches a known fuel vapor processing apparatus that includes a case and an adsorption material having a honeycomb structure (hereinafter called a “honeycomb adsorption member”). The case includes a charge port and a purge port that are disposed at one end of a gas passage defined in the case for introduction of fuel vapor containing gas and for purging fuel vapor from the gas passage, respectively. The case further includes an atmospheric port disposed at the other end of the gas passage for introduction of air used for purging fuel vapor. The honeycomb adsorption member is disposed within the gas passage and capable of adsorbing fuel vapor and allowing desorption of fuel vapor. The honeycomb adsorption member allows gas to flow therethrough in a direction of flow of the gas through the gas passage. A filter is disposed between the atmospheric port and the honeycomb adsorption member.

JP-A-2008-138580 teaches a filter used for a fuel vapor processing apparatus and disposed on an atmospheric side of a granular adsorption material. The filter has a multi-layer structure with a coarse layer positioned on an upstream side with respect to a direction of flow of purge air and a fine layer positioned on a downstream side of the coarse layer.

In the case of the fuel vapor processing apparatus disclosed in JP-A-2009-195007, if the flow rate of the purge air during the purge operation is high, it may be possible that the purge air may not be sufficiently diffused by the filter but preferentially flows though the central portion of the honeycomb adsorption member. Therefore, fuel vapor adsorbed by the outer peripheral portion of the honeycomb adsorption member may not be sufficiently desorbed, resulting in low desorption efficiency of fuel vapor. If the fuel vapor remains in or on the honeycomb adsorption member without being desorbed, a problem may be caused that fuel vapor may be blown toward the atmospheric port during filling of fuel or other occasion. Thus, the amount of fuel blown toward the atmospheric port (hereinafter called a “blow-through amount”) may increase as the amount of fuel remaining in or on the honeycomb adsorption member (hereinafter called a “residual amount”) increases.

Even with the use of the filter disposed on the atmospheric side of the granular adsorption material and having the coarse layer and the fine layer arranged in a manner overlapped with each other in a direction of flow of purge air from the atmosphere as taught by JP-A-2008-138580, it is not possible to expect sufficient diffusion of purge air.

Therefore, there has been a need in the art for a fuel vapor processing apparatus that can improve the fuel vapor desorption efficiency and can reduce the residual amount or the blow-through amount of fuel vapor.

### SUMMARY OF THE INVENTION

In one aspect according to the present teachings, a fuel vapor processing apparatus may include a case defining therein a flow passage including an adsorption chamber, an adsorption material disposed in the adsorption chamber, and a density gradient filter disposed in the flow passage at a position on an upstream side of the adsorption material with respect to a direction of flow of purge air for desorbing fuel vapor from the adsorption material. The density gradient filter may include a first portion having a first density, a second portion having a second density, and a third portion having a third density. The third portion may be positioned on a downstream side of the first portion with respect to the direction of flow of the purge air. The second portion may be positioned between the first portion and the third portion. Each of the first density and the third density may be higher than the second density.

### BRIEF DESCRIPTION OF THE DRAWINGS

FIG. 1 is a horizontal sectional view of a fuel vapor processing apparatus according to a first embodiment;

FIG. 2 is an enlarged view of a portion II indicated in FIG. 1;

FIG. 3 is an enlarged view similar to FIG. 1 but showing a part of a fuel vapor processing apparatus according to a second embodiment; and

FIG. 4 is a plan view, with a part shown in horizontal sectional view, of a fuel vapor processing apparatus according to a third embodiment.

### DETAILED DESCRIPTION OF THE INVENTION

Each of the additional features and teachings disclosed above and below may be utilized separately or in conjunction with other features and teachings to provide improved fuel vapor processing apparatus. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one example, a fuel vapor processing apparatus may include a case defining a gas passage therein and having a charge port for introduction of fuel vapor containing gas, a purge port through which fuel vapor is purged from the gas passage, and an atmospheric port for introduction of purge air. The charge port and the purge port may be disposed on one side of the gas passage, and the atmospheric port may be disposed on the other side of the gas passage. A honeycomb adsorption member may be disposed within the gas passage and may adsorb fuel vapor and allow desorption of fuel vapor. The honeycomb adsorption member may have a honeycomb structure and may allow flow of gas therethrough in a direction along the gas passage. A density gradient filter may be disposed within the gas passage at a position between the atmospheric port and the honeycomb adsorption member to cause diffusion of the purge air as the purge air flows through the density gradient filter from the atmospheric port to the honeycomb adsorption member. The density gradient filter may include a first fine layer, a first coarse layer disposed on a downstream side of the first fine layer with respect to a direction of flow of the purge air, and a second fine layer disposed on the downstream side of the first coarse layer.

With this arrangement, during the purge operation, the purge air flowing from the atmospheric port to the honeycomb adsorption member may be gradually diffused as the purge air flows through the density gradient filter. Therefore, the diffused purge air may flow through the honeycomb adsorption member substantially uniformly over its entire cross sectional area. In addition, because the first coarse layer is disposed between the first and second fine layers, it is possible to effectively diffuse the purge air. As a result, desorption efficiency of fuel vapor from the honeycomb adsorption member can be improved to reduce the residual amount of fuel vapor and eventually the blow-through amount of fuel vapor.

The density gradient filter may further include a second coarse layer disposed on the downstream side of the second fine layer or on an upstream side of the first fine layer with respect to the direction of flow of the purge air. With this arrangement, the diffusing effect for the purge air can be further improved.

In another embodiment, the density gradient filter may include plural sets of a fine layer and a coarse layer arranged along a direction of flow of the purge air. The fine layer and the coarse layer in each set may be arranged to be adjacent to the coarse layer portion and the fine layer, respectively, of the other set positioned adjacent each set. Because the fine layer and the coarse layer in each set can be handled together, the operation for assembling the density gradient filter into the case can be easily performed.

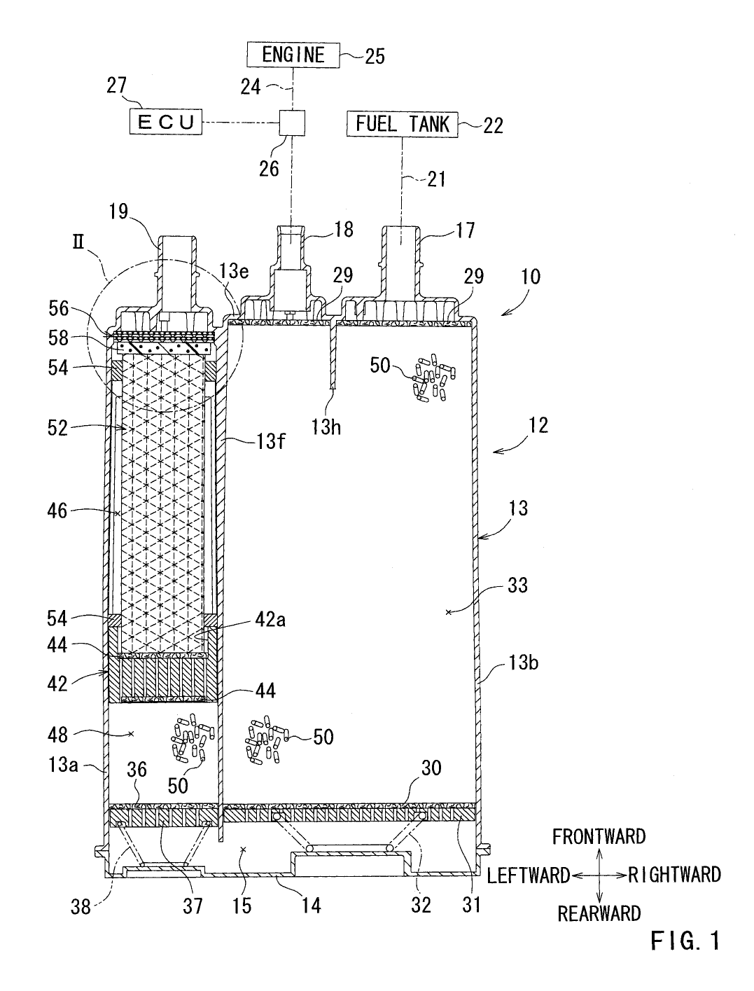

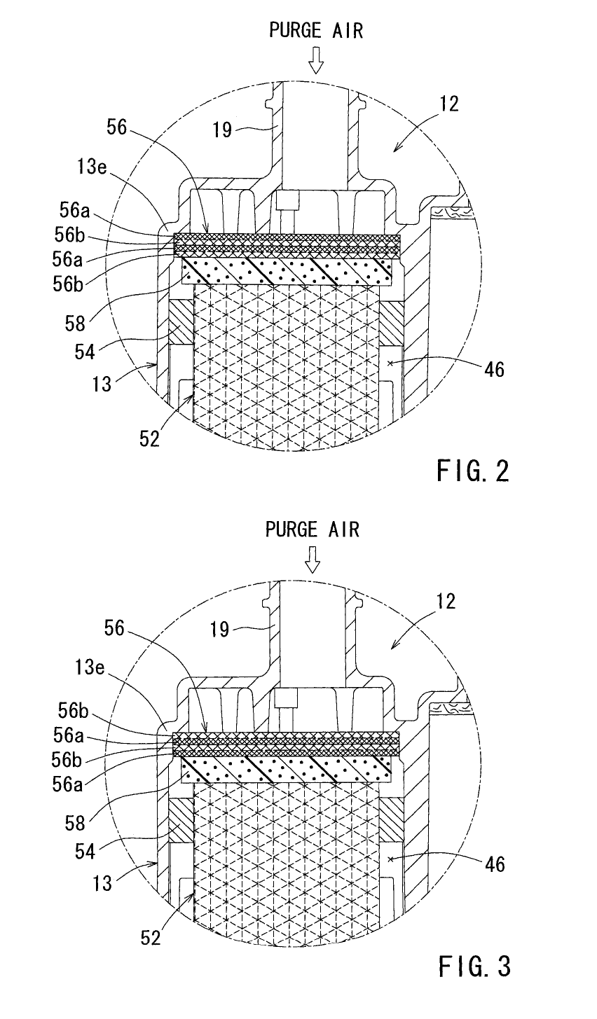

A first embodiment will now be described with reference to FIGS. 1 and 2. Referring to FIGS. 1 and 2, there is shown a fuel vapor processing apparatus that may be called as a canister and can be installed on a vehicle, such as an automobile. For convenience of explanation, the basic structure of the fuel vapor processing apparatus will be first explained, and an explanation of details of the apparatus will follow. In addition, for the purpose of explanation, a front side, a rear side, a left side and a right side of the apparatus are determined on the basis of a horizontal sectional view of the apparatus shown in FIG. 1 (see arrows in FIG. 1).

The basic structure of the apparatus will now be described. As shown in FIG. 1, the apparatus includes a case 12 having a rectangular box shape. The case 12 may be made of resin and may include a case body 13. The case body 13 may have a rectangular parallelepiped shape and includes an end wall 13e for closing the front end of the case body 13. The case body 13 has a rear opening that may be closed by a closure member 14. A partition wall 13f may be formed within the case body 13 to extend parallel to a left wall 13a and a right wall 13b of the case body 13, an that the space within the case body 13 may be separated into left and right chambers by the partition wall 13f. The left and right chambers of the case body 13 may communicate with each other via a communication passage 15 that is formed between the case body 13 and the closure member 14. Therefore, the left and right chambers of the case body 13 and the communication passage 15 may form a substantially U-shaped path for the flow of gas.

A tank port 17 and a purge port 18 may be formed on the end wall 13e of the case body 13 in communication with the right chamber of the case body 13. An atmospheric port 19 also may be formed on the end wall 13e. However, the atmospheric port 19 is in communicates with the left chamber of the case body 13. The tank port 17 may communicate with a fuel tank 22 (more specifically, a gaseous phase space (not shown) formed in the fuel tank 22) via a fuel vapor passage 21. The purge port 18 may communicate with an engine 25 (more specifically, an intake pipe at a position on the downstream side of a throttle valve (not shown)) via a purge passage 24. A purge valve 26 may be disposed in the midway of the purge passage 24. An engine control unit (ECU) 27 may control the purge valve 26 for opening and closing the same. The atmospheric port 19 may be opened to the atmosphere. The ports 17, 18 and 19 may protrude frontwardly from the end wall 13e of the case body 13. The tank port 17 may be hereinafter also called as a charge port 17. The engine 25 may be an internal combustion engine. The ECU 27 may be simply called as a controller 27.

The front end portion of the right chamber of the case body 13 may be divided into left and right side portions, i.e., a portion on the side of the purge port 18 and a portion on the side of the tank port 17, by a partition wall 13h formed on the end wall 13e and protruding into the right chamber. A perforated plate 31 may be slidably fitted within a right side part (i.e., a part on the side of the right chamber) of the rear opening of the case body 13 and may extend across substantially the entire cross sectional area of the right side part. The perforated plate 31 allows gas to flow therethrough and may be made of resin. With this arrangement, an adsorption chamber 33 may be defined within the right chamber of the case body 13.

Front filters 29 may be attached to the end wall 13e of the case body 13 at a position of the front end of the adsorption chamber 33 so as to extend across substantially the entire cross sectional area of the front end of the adsorption chamber 33, so that the front filters 29 are opposed to the tank port 17 and the purge port 18, respectively. A rear filter 30 may be attached to the front surface of the perforated plate 31 so as to be overlapped therewith. A spring 32 may be interposed between the perforated plate 31 and the surface of the closure member 14, so that the perforated plate 31 may be normally biased frontwardly by the spring 32. The spring 32 may be a coil spring.

A retainer member 42 may be received within the left chamber of the case body 13 at a substantially intermediate position with respect to the frontward and rearward direction that is a direction along a straight path portion of a flow path of gas thorough the apparatus 10. Therefore, an adsorption chamber 46 may be defined on the front side of the retainer member 42 within the left chamber of the case body 13. A perforated plate 37 may be slidably fitted within a left side part (i.e., a part on the side of the left chamber) of the rear opening of the case body 13 and may extend across substantially the entire cross sectional area of the left side part. The perforated plate 37 allows gas to flow therethrough and may be made of resin. With this arrangement, an adsorption chamber 48 may be defined within the left chamber of the case body 13 at a position on the rear side of the retainer member 42. For the purpose of explanation, the adsorption chamber 46, the adsorption chamber 48 and the adsorption chamber 33 may be also called as a first adsorption chamber 46, a second adsorption chamber 48 and a third adsorption chamber 33, respectively.

The retainer member 42 may be made of resin and may be formed of a perforated plate for allowing gas to flow therethrough. Filters 44 may be fitted into front and rear ends of the retainer member 42 to extend across the entire cross sectional area of the retainer member 42. A honeycomb adsorption member 52 is received within the first adsorption chamber 46. In this embodiment, the honeycomb adsorption member 52 has a cylindrical shape and is formed with a plurality of parallel gas flow passages (not shown) extending in the axial direction (frontward and rearward direction in FIG. 1). In other words, the honeycomb adsorption member 52 allows flow of gas along the straight gas path portion. The honeycomb adsorption member 52 may be made of a material that can adsorb fuel vapor and can allow desorption of fuel vapor. For example, a mixture at a predetermined mixing ratio of a high heat capacity material, such as ceramic, and an adsorption material, such as activated carbon, may be molded into a predetermined shape (such as a cylindrical shape) and may be thereafter fired to form the honeycomb adsorption member 53. Therefore, the honeycomb member 53 may be called a honeycomb activated carbon. The honeycomb adsorption member 53 may be resiliently supported by the inner circumferential wall of the left chamber of the case body 13 via a pair of front and rear seal rings 54 that may be made of resilient material.

The rear end of the honeycomb adsorption member 52 may be fitted into a fitting recess 42a formed in the front portion of the retainer member 42 so as to be supported by the retainer member 42. The rear end surface of the adsorption member 52 may face to the filter 44 fitted into the front end of the retainer member 42.

A filter 36 may be attached to the front surface of the perforation plate 37 so as to he overlapped therewith. A spring 38 may be interposed between the perforated plate 37 and the surface of the closure member 14, no that the perforated plate 37 may be normally biased frontwardly by the spring 37. The spring 37 may be a coil spring.

A granular adsorption material 50 capable of adsorbing fuel vapor and allowing desorption of fuel vapor may be filled within each of the second and third adsorption chambers 48 and 33. More specifically, for the second adsorption chamber 48, the granular adsorption material 50 may be filled between the filter 44 fitted into the rear end of the retainer member 42 and the filter 36 positioned at the rear end of the second adsorption chamber 48. For the third adsorption chamber 33, the granular adsorption material 50 may be filled between the filter 30 positioned at the rear end of the third adsorption chamber 33 and the filters 29 positioned at the front end of the third adsorption chamber 33. Activated carbon granules may be used as the granular adsorption material 50. The activated carbon granules may be pulverized activated carbon or may be granulated or palletized activated carbon formed from a mixture of activated carbon powder and a binder. Each of the filters 29, 30, 36 and 44 may be made of non-woven resin fabric, urethane foam or any other suitable material.

A fuel vapor processing system incorporating the fuel vapor processing apparatus 10 will now be described with reference to FIG. 1. The fuel vapor processing system may include the fuel vapor processing apparatus 10, the fuel vapor passage 21, the purge valve 26 and the ECU 27.

In the state where the engine 25 of the vehicle is stopped, the purge valve 26 may be closed. Therefore, gas that may contain fuel vapor (hereinafter called “fuel vapor containing gas) produced within the fuel tank 22 may be introduced into the third adsorption chamber 33 via the fuel vapor passage 21 and the tank port 17. Then, the granular adsorption material 50 filled within the third adsorption chamber 33 may adsorb fuel vapor contained in the fuel vapor containing gas. If the fuel vapor has not been completely adsorbed by the adsorption material 50 of the third adsorption chamber 33, the remaining fuel vapor may flow into the second adsorption chamber 48 via the communication passage 15 and may be adsorbed by the granular adsorption material 50 of the second adsorption chamber 48. If the remaining fuel vapor still has not been completely adsorbed by the granular adsorption material 50 of the second adsorption camber 48, the remaining fuel vapor may be introduced into the first adsorption chamber 46 so as to be adsorbed by the honeycomb adsorption member 52 of the first adsorption chamber 46. Therefore, the gas that contains almost only air may be discharged to the atmosphere via the atmospheric port 19.

On the other hand, during the purge operation (more specifically, during the purge control operation performed when the engine 25 is being driven), the purge valve 26 may be opened, so that a negative pressure of intake air may be applied to the gas passage of the case 12 via the purge passage 24 and the purge port 18. In association with this, the atmospheric air (fresh air) may be introduced into the first adsorption chamber 46 as purge air via the atmospheric port 19. The purge air introduced into the first adsorption chamber 46 may desorb fuel vapor from the honeycomb adsorption member 52 of the first adsorption chamber 46 and may then be introduced into the second adsorption chamber 48, so that fuel vapor may be desorbed from the adsorption material 50 of the second adsorption chamber 48. Thereafter, the purge air containing the desorbed fuel vapor may be introduced into the third adsorption chamber 33 via the communication passage 15, so that fuel vapor may be desorbed also from the adsorption material 50 of the third adsorption chamber 33. The purge air containing the desorbed fuel vapor may subsequently flow into the engine 25 via the purge port 18 and the purge passage 24, so that the fuel vapor contained in the purge air may be burned within the engine 25.

The fuel vapor processing apparatus will be further described in detail. As shown in FIG. 2 that is an enlarged view of a part of FIG. 2, a density gradient filter 56 may be disposed within the first adsorption chamber 46 at a position between the atmospheric port 18 (more specifically, the end wall 13e of the case body 13) and the honeycomb adsorption member 52 to extend across substantially the entire cross sectional area of the front end of the first adsorption chamber 46. In this embodiment, the density gradient filter 56 may have a four-layer structure including first and second fine layers 56a and first and second coarse layers 56b. Thus, density of the first and second fine layers 57a is higher than that of the first and second coarse layers 56b. The first fine layer 56a is disposed on the most upstream side with respect to the direction of flow of purge air (downward direction as viewed in FIG. 2), the first coarse layer 56b is disposed on the downstream side of the first fine layer 56a, the second fine layer 56a is disposed on the downstream side of the first coarse layer 56b, and the second coarse layer 56b is disposed on the downstream side of the second fine layer 56a. The first and second fine layers 56a as well as the first and second coarse layers 56a may be formed of sheets made of non-woven fabrics. The first fine layer 56a and the first coarse layer 56b may be combined as a first set of fine and coarse layers, and the second fine layer 56a and the second coarse layer 56b may be combined as a second set of fine and coarse layers positioned parallel to the first set of fine and coarse layers. In such a case, each of the first and second sets of fine and coarse layers may be formed as a single filter having the fine layer 56a and the coarse layer 56b that are integrated with each other by joining together.

A protective member 58 may be interposed between the density gradient filter 56 and the honeycomb adsorption member 52. The protective member 58 may be made of a material, such as foam urethane, that can allow gas to flow therethrough. The protective member 58 is provided for protecting the honeycomb adsorption member 52. Therefore, the protective member 58 may be coarser in density than the coarse layers 56b of the density gradient filter 56. The protective member 58 may be provided if necessary or appropriate and may be omitted in some cases.

With the fuel vapor processing apparatus 10 of this embodiment, during the purge operation, purge air flowing from the atmospheric port 19 toward the honeycomb adsorption member 52 may be gradually diffused as it flows through the first tine layer 56a, the first coarse layer 56b, the second fine layer 56a and the second coarse layer 56h of the density gradient filter 45 in this order. The diffused purge air may flow through the honeycomb adsorption member 52 substantially uniformly over its entire cross sectional area. In addition, because the first coarse layer 56b is positioned between the first and second fine layers 56a, the purge air can be efficiently diffused. Therefore, desorption efficiency of fuel vapor from the honeycomb adsorption member 52 can be improved to reduce the residual amount of fuel vapor and eventually the blow-through amount of fuel vapor.

Additionally, the density gradient filter 56 includes the second coarse layer 56b positioned on the downstream side of the second fine layer 56a. Therefore, it is possible to further enhance the effect of diffusing the purge air. This arrangement is also advantageous for preventing clogging due to foreign materials, such as particles of adsorption material, that may come from the downstream side with respect to the flow of purge air (i.e., from the side of the honeycomb adsorption member 32).

Further, because the density gradient filter 56 includes two sets of the fine layer 56a and the coarse layer 56b, the density gradient filter 56 may be easily assembled within the case body 13. It may be possible to provide three or more sets of the fine layer 56a and the coarse layer 56b.

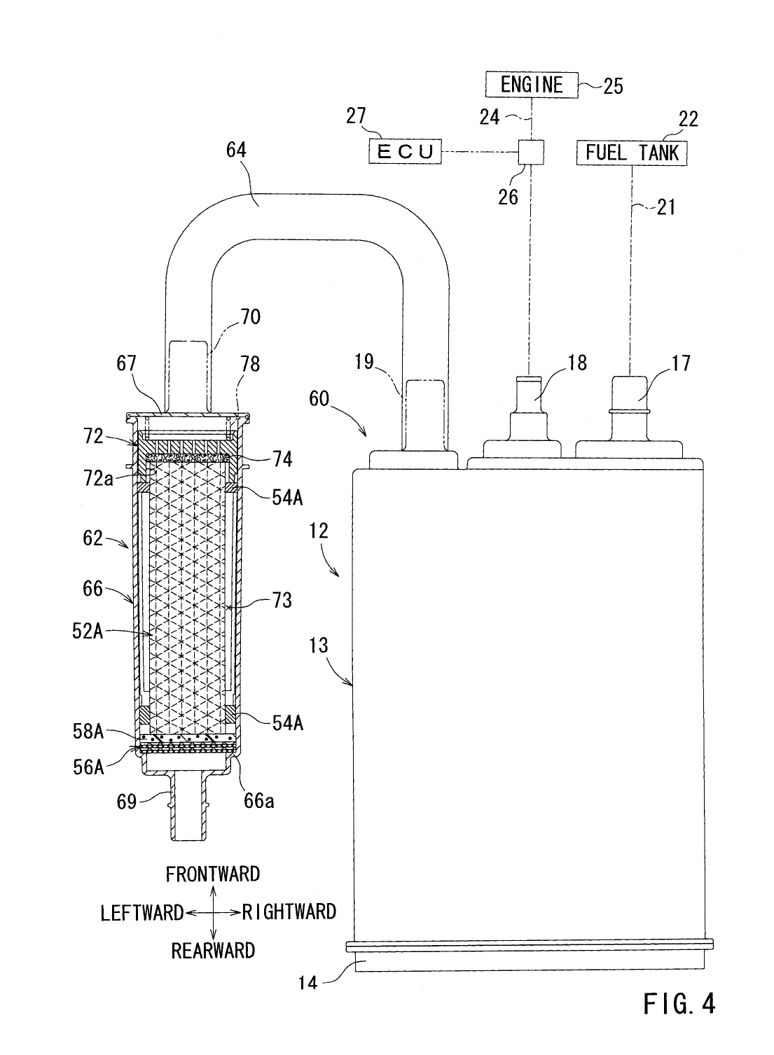

Second and third embodiments will now be described with reference to FIGS. 3 and 4, These embodiments are modifications of the first embodiment. Therefore, in FIGS. 3 and 4, like members are given the same reference signs as the first embodiment and the description of these elements will not repeated.

The second embodiment will be described with reference to FIG. 3. As shown in FIG. 3, in this embodiment, the arrangement of the fine layer 56a and the coarse layer 56b in each set is inverted with respect to the direction of flow of purge air such that the fine layer 56a is positioned on the downstream side of the coarse layer 56b. Thus, the density gradient filter 56 of this embodiment has the first coarse layer 56b disposed on the most upstream side with respect to the direction of flow of the purge air (downward direction as viewed in FIG. 3), the first fine layer 56a disposed on the downstream side of the first coarse layer 56b, the second coarse layer 56b disposed on the downstream side of the first fine layer 56b, and the second fine layer 56a disposed on the downstream side of the second coarse layer 56b.

According to this embodiment, the first coarse layer 56b is disposed on the upstream side of the first fine layer 56a. With this arrangement, it is also possible to further enhance the effect of diffusing the purge air. This arrangement is also advantageous for preventing clogging due to foreign materials that may come from the downstream side with respect to the flow of purge air.

The third embodiment will now be described with reference to FIG. 4. A fuel vapor processing apparatus 60 of this embodiment includes a case 62 in addition to the case 12 of the first embodiment. For the purpose of explanation, the case 12 and the 62 will be called as a primary case 12 and a secondary case 62, respectively. In this connection, the atmospheric port 19 of the primary case 12 (see FIG. 1) serves as a connection port for connection with the secondary case 62 via a connection pipe 64. Therefore, in this embodiment, the atmospheric port 19 may be called as a connection port 19 that is connected to one end of the connection pipe 64. Although not shown in FIG. 4, in this embodiment, the retaining member 42, the honeycomb adsorption member 52, the seal rings 54, the density gradient filter 56 and the protective member 58 disposed within the left chamber of the case body 13 of the first embodiment are omitted, so that the first adsorption chamber 46 and the second adsorption chamber 48 are replaced with a single adsorption chamber, in which the granular adsorption material 50 of the first embodiment may be filled.

The secondary case 62 may be made of resin and may include a case member 66 having a substantially cylindrical tubular shape and a closure plate 67 for closing an open end of the case member 66. In FIG. 4, the secondary case 62 is positioned such that the bottom of the case member 66 is positioned on the rear side and the closure plate 67 is positioned on the front side. The case member 66 has a rear end wall 66a, from which an atmospheric port 69 protrudes rearwardly (downwardly as viewed in FIG. 4) so as to be coaxial with the rear end wall 66a. The atmospheric port 69 communicates within the case member 66 and is opened into the atmosphere. A connection port 70 is formed on the closure plate 67 and protrudes frontwardly (upwardly as viewed in FIG. 4) so as to be coaxial with the closure plate 67. The connection port 70 also communicates within the case member 66 and is connected to the other end of the connection pipe 64. Therefore, inside of the primary case 12 and inside of the secondary case 62 communicate with each other via the connection pipe 64 that serves as a piping member.

The internal space of the secondary case 62 (more specifically, the internal space of the case member 66) serves as a gas passage. A retainer member 72 is fitted within the front end portion of the case member 66, so that an adsorption chamber 73 may be defined within the case member 66 on the rear side of the retainer member 72. The retainer member 72 may be made of resin and may be formed of a perforated plate for allowing gas to flow therethrough. A filter 74 may be fitted into the rear end of the retainer member 72 to extend across the entire cross sectional area of the retainer member 72. The filter 74 may be made of non-woven resin fabric, urethane foam or any other suitable material.

A honeycomb adsorption member 52A is received within the adsorption chamber 73. The shape and the material of the honeycomb 52A may be similar to those of the honeycomb adsorption member 52 of the first embodiment. The honeycomb adsorption member 52A may be resiliently supported by the inner circumferential wall of the case member 66 via a pair of front and rear seal rings 54A that may be similar to the seal rings 54 of the first embodiment. The front end of the honeycomb adsorption member 52A may be fitted into a fitting recess 72a formed in the rear portion of the retainer member 72 so as to be supported by the retainer member 72. The front end surface of the adsorption member 52A may face to the filter 74 of the retainer member 72. A density gradient filter 56A and a protective member 58A similar to the density gradient filter 56 and the protective member 58 of the first embodiment, respectively, may be disposed within the adsorption chamber 73 at a position between the atmospheric port 69 (more specifically, the end wall 66a of the case member 66) and the honeycomb adsorption member 52A. A spring 78 may be interposed between the retainer member 72 and the surface of the closure member 67, so that the retainer member 72 may be normally biased rearwardly by the spring 78. The spring 78 may be a coil spring.

With the fuel vapor processing apparatus 60 of this embodiment, in the state where the engine 25 of the vehicle is stopped, the purge valve 26 may be closed. Therefore, fuel vapor containing gas produced within the fuel tank 22 may be introduced into the gas passage of the primary case 12 via the tank port 17. Then, the granular adsorption materials tilled within the primary case 12 (more. specifically, the granular adsorption materials 50 filled within the adsorption chamber 33 and the single adsorption chamber on the side of the left chamber) may adsorb fuel vapor contained in the fuel vapor containing gas. Therefore, the gas that contains almost only air may be introduced into the adsorption chamber 73 of the secondary case 62 via the connection port 19, the connection pipe 64 and the connection port 70. If the gas still contains fuel vapor, such fuel vapor may be adsorbed by the honeycomb adsorption member 52A. The gas may then be discharged from the atmospheric port 69 to the atmosphere.

On the other hand, during the purge operation (more specifically, during the purge control operation performed when the engine 25 is being driven), the purge valve 26 may be opened, so that a negative pressure of intake air may be applied to the gas passage of the primary case 12 via the purge passage 24 and the purge port 18. In association with this, the atmospheric air (fresh air) may be introduced into the adsorption chamber 73 as purge air via the atmospheric port 69. The purge air introduced into the adsorption chamber 73 may desorb fuel vapor from the honeycomb adsorption member 52A of the adsorption chamber 73 and may then be introduced into the gas passage of the primary case 12, so that fuel vapor may be desorbed from the granular adsorption materials 50 of the primary case 12. The purge air containing the desorbed fuel vapor may subsequently flow into the engine 25 via the purge port 18 and the purge passage 24, so that the fuel vapor contained in the purge air may be burned within the engine 25. During the purge operation, the purge air flowing from the atmospheric port 69 toward the honeycomb adsorption member 52A may be gradually diffused as it flows through the density gradient filter 56A. The diffused purge air may flow through the honeycomb adsorption member 52A substantially uniformly over the entire cross sectional area. The density gradient filter 56A may include two sets of the fine layer 56a and the coarse layer 56b arranged in the same manner as the density gradient filter 56 of the first embodiment or the second embodiment.

The above embodiments may be modified in various ways. For example, the fuel vapor processing apparatus 10(60) may be mounted to a vehicle in various positions and orientations other than those disclosed above. Further, each of the fine layers 56a and the coarse layers 56b of the density gradient filter 56(56A) may be mounted individually into the case member 13 (66). Further, the density of the first fine layer 56a and the density of the second fine layer 56a may be the same or may be different from each other. Similarly, the density of the first coarse layer 56b and the density of the second coarse layer 56b may be the same or may be different from each other. Further, the fine layer 56a and the coarse layer 56b in each set may be separate portions that are overlapped with each other for handling as a set. In such a case, the second coarse layer 56b of the density gradient filter 56 of the first embodiment (see FIG. 2), which faces to the protective member 58, may be omitted, and the first coarse layer 56b of the density gradient filter 56 of the second embodiment (see FIG. 3), which faces to the atmospheric port 19, may be omitted. Furthermore, the material of the density gradient filter 56 may not be limited to the non-woven fabric but may be urethane foam.

What is claimed is:

1. A fuel vapor processing apparatus comprising:
a case defining a gas passage therein and having a charge port for introduction of fuel vapor containing gas, a purge port through which fuel vapor is purged from the gas passage, and an atmospheric port for introduction of purge air;
wherein the charge port and the purge port are disposed on one side of the gas passage, and the atmospheric port is disposed on the other side of the gas passage;
a honeycomb adsorption member disposed within the gas passage and capable of adsorbing fuel vapor and allowing desorption of fuel vapor, the honeycomb adsorption member having a honeycomb structure and allowing flow of gas therethrough in a direction of flow through the gas passage; and
a density gradient filter disposed within the gas passage at a position between the atmospheric port and the honeycomb adsorption member to cause diffusion of the purge air as the purge air flows through the density gradient filter from the atmospheric port to the honeycomb adsorption member;
wherein the density gradient filter includes a first fine layer, a first coarse layer disposed on a downstream side of the first fine layer with respect to a direction of flow of the purge air, and a second fine layer disposed on the downstream side of the first coarse layer.

2. The fuel vapor processing apparatus as in claim 1, wherein the density gradient filter further includes a second coarse layer disposed on the downstream side of the second fine layer.

3. The fuel vapor processing apparatus as in claim 1, wherein the density gradient filter further includes a second coarse layer disposed on an upstream side of the first fine layer with respect to the direction of flow of the purge air.

4. A fuel vapor processing apparatus comprising:
a case defining a gas passage therein and having a charge port for introduction of fuel vapor containing gas, a purge port through which fuel vapor is purged from the gas passage, and an atmospheric port for introduction of purge air;
wherein the charge port and the purge port are disposed on one side of the gas passage, and the atmospheric port is disposed on the other side of the gas passage;
a honeycomb adsorption member disposed within the gas passage and capable of adsorbing fuel vapor and allowing desorption of fuel vapor, the honeycomb adsorption member having a honeycomb structure and allowing flow of gas therethrough in a direction of flow through the gas passage; and
a density gradient filter disposed within the gas passage at a position between the atmospheric port and the honeycomb adsorption member to cause diffusion of purge air as the purge air flows through the density gradient filter from the atmospheric port to the honeycomb adsorption member;
wherein the density gradient filter includes plural sets of a fine layer and a coarse layer arranged along a direction of flow of the purge air;
wherein the fine layer in each set is arranged to be adjacent to the coarse layer portion of the other set positioned adjacent each set; and
wherein the coarse layer in each set is arranged to be adjacent to the fine layer of the other set positioned adjacent each set.

5. A fuel vapor processing apparatus comprising:
a case defining therein a flow passage including an adsorption chamber;
an adsorption material disposed in the adsorption chamber; and
a density gradient filter disposed in the flow passage at a position on an upstream side of the adsorption material with respect to a direction of flow of purge air for desorbing fuel vapor from the adsorption material;
wherein the density gradient filter includes a first portion having a first density, a second portion having a second density, and a third portion having a third density, the third portion being positioned on a downstream side of the first portion with respect to the direction of flow of the purge air and the second portion being positioned between the first portion and the third portion,
wherein each of the first density and the third density is higher than the second density.

6. The fuel vapor processing apparatus as in claim 5, wherein the density gradient filter further includes a fourth portion having a fourth density and disposed on an upstream side of the first portion with respect to the direction of flow of the purge air, and the fourth density is lower than the first density.

7. The fuel vapor processing apparatus as in claim 5, wherein the density gradient filter further includes a fourth portion having a fourth density and disposed on the downstream side of the third portion with respect to the direction of flow of the purge air, and the fourth density is lower than the third density.

8. The fuel vapor processing apparatus as in claim 5, wherein the adsorption material is a honeycomb adsorption member.
